(19) United States
(12) Patent Application Publication
(10) Pub. No.: US 2025/0029483 A1
(43) Pub. Date: Jan. 23, 2025

(54) REAL-TIME TRAFFIC INFORMATION GENERATION USING SMART TRAFFIC SIGNALS

(71) Applicant: Charter Communications Operating, LLC, St. Louis, MO (US)

(72) Inventors: Vishal G. Chopade, Castle Pines, CO (US); Mohamed Daoud, Aurora, CO (US); Hany A. Heikal, Aurora, CO (US)

(21) Appl. No.: 18/353,574

(22) Filed: Jul. 17, 2023

(51) Int. Cl. G08G 1/01; G06V 10/70; G06V 20/54; G08G 1/0968

(52) U.S. Cl. CPC G08G 1/0141; G06V 10/70; G06V 20/54; G08G 1/0116; G08G 1/0133; G08G 1/096844; G06V 2201/08

(57) ABSTRACT

A computing device may receive traffic data from a plurality of traffic signals. The computing device may store the traffic data in a data structure. The computing device may receive a request for information associated with the traffic data from a computing device. The computing device may generate a result based on the traffic data and the request for information associated with the traffic data. The computing device may send the result to another computing device.

### BACKGROUND

Traffic congestion on roads can cause problems, such as delays for drivers and hindering the ability of first responders to quickly arrive at a destination. Users, autonomous vehicles, and user computing devices with mapping applications may not receive accurate traffic information to be able to quickly re-route when roads are congested.

### SUMMARY

The examples disclosed herein perform real-time traffic information generation using smart traffic signals by using real-time data from traffic signals to reduce delays for users and optimize traffic flow. Real-time data may be received from the traffic signals and stored in a database associated with a central computing system. The real-time data may be retrieved from the database and used to generate an outcome based on a request from a user or a computing device. The outcome may be used by the user or the computing device to make informed route decisions that reduce delays during travel and optimize traffic flow of the roads.

In one example, a method for real-time traffic information generation using smart traffic signals is provided. The method includes receiving, by a central computing device comprising a data structure, traffic data from a plurality of traffic signals. The method further includes storing, by the central computing device, the traffic data in the data structure. The method further includes receiving, by the central computing device, a request for information associated with the traffic data from a computing device. The method further includes generating, by the central computing device, a result based on the traffic data and the request for information associated with the traffic data. The method further includes sending, by the central computing device, the result to the computing device.

In another example, a computing device for real-time traffic information generation using smart traffic signals is provided. The computing device includes a memory and a processor device coupled to the memory. The processor device is to receive traffic data from a plurality of traffic signals. The processor device is further to store the traffic data in a data structure. The processor device is further to receive a request for information associated with the traffic data from a computing device. The processor device is further to generate a result based on the traffic data and the request for information associated with the traffic data. The processor device is further to send the result to the computing device.

In another example, a non-transitory computer-readable storage medium for real-time traffic information generation using smart traffic signals is provided. The non-transitory computer-readable storage medium includes computer-executable instructions to cause a processor device to receive traffic data from a plurality of traffic signals. The instructions further cause the processor device to store the traffic data in a data structure. The instructions further cause the processor device to receive a request for information associated with the traffic data from a computing device. The instructions further cause the processor device to generate a result based on the traffic data and the request for information associated with the traffic data. The instructions further cause the processor device to send the result to the computing device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing system in which examples of real-time traffic information generation using smart traffic signals may be practiced;

FIG. 2 is a flowchart illustrating operations performed by the computing system of FIG. 1 for real-time traffic information generation using smart traffic signals, according to one example;

FIG. 3 is a block diagram of the computing system of FIG. 1 for real-time traffic information generation using smart traffic signals, according to one example;

FIG. 4 is a block diagram of the computing system of FIG. 1 for real-time traffic information generation using smart traffic signals, according to one example; and

FIG. 5 is a block diagram of a computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the elements unless otherwise explicitly specified. The word “or” as used herein and in the claims is inclusive unless contextually impossible. As an example, the recitation of A or B means A, or B, or both A and B. The word “data” may be used herein in the singular or plural depending on the context.

Traffic congestion on roads can cause problems, such as delays for drivers and hindering the ability of first responders to quickly arrive at a destination. Users, autonomous vehicles, and user computing devices with mapping applications may not receive accurate traffic information to be able to quickly re-route when roads are congested.

The examples disclosed herein perform real-time traffic information generation using smart traffic signals by using real-time data from traffic signals to reduce delays for users and optimize traffic flow. A central computing system may receive real-time data from the traffic signals that is associated with the traffic on the roads where the traffic signals operate. The real-time data can be stored in a data structure, such as a database, associated with the central computing system, to be securely stored and easily accessed by computing devices and applications. The central computing system may retrieve the real-time data from the data structure and use the real-time data to generate an outcome based on a request from a user or a computing device, such as an autonomous vehicle or a mapping application on a user computing device.

The central computing system may generate the outcome by using a machine-learning model, images taken by cameras associated with the traffic signals, and vehicle speed information obtained by sensors associated with the traffic signals. The machine-learning model may determine, based on the images and/or the vehicle speed information, an amount of current traffic congestion and generate a route to avoid and alleviate the traffic congestion. The user or the computing device can use the route as the outcome to make informed route decisions that reduce delays during travel and optimize traffic flow of the roads.

The central computing system may send the outcome to the user or computing device, such as sending the route generated by the machine-learning model of the central computing system to a user computing device, autonomous vehicle, or a computing device in a first responder vehicle. The central computing system may send the real-time data to a computing device and the computing device, such as via a mapping application, can generate a traffic map or route based on the real-time data obtained from the traffic signals. As a result, traffic congestion and delays for drivers can be reduced in real-time.

Processing the traffic data and generating information by the central computing system allows for increased scalability and reduced downtime risks, and can be accomplished without on-premise hardware installation, such as when the central computing system is cloud-based. The central computing system facilitates real-time mapping applications of computing devices by providing such precise traffic information in real-time.

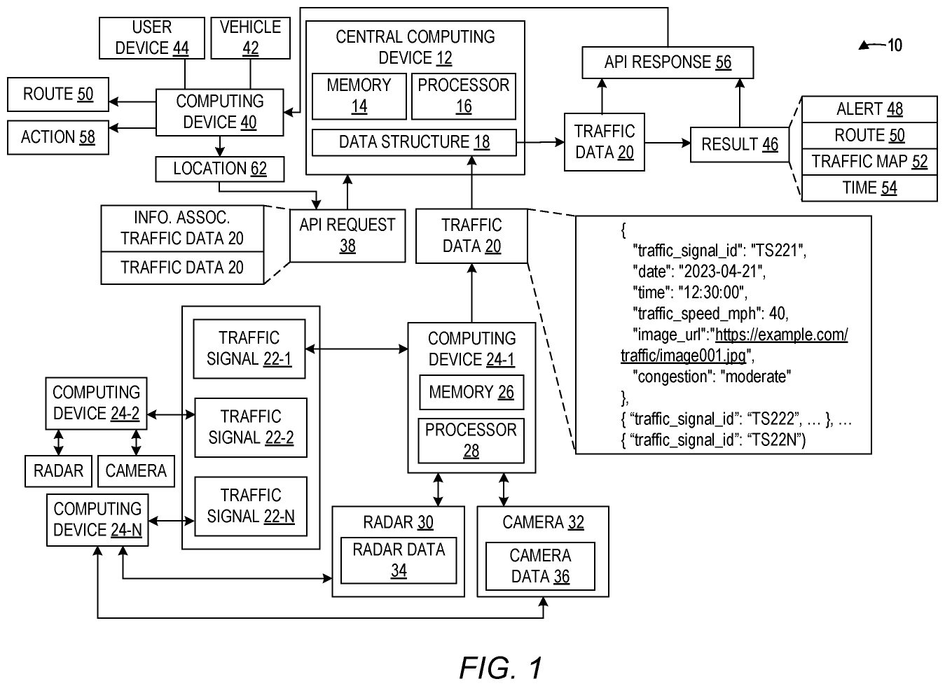

FIG. 1 is a block diagram of a computing system 10 in which examples of real-time traffic information generation using smart traffic signals may be practiced. The computing system 10 includes a central computing device 12 that comprises a memory 14, a processor device 16, and a data structure 18. The central computing device 12 may be a cloud computing device, a server device, an edge device, or any other type of computing device that is centralized and communicates with other computing devices via one or more networks. The data structure 18 may be a database, a table, an array, a graph, or a tree, as non-limiting examples. Although only the central computing device 12 is illustrated with a memory 14 and a processor device 16, any component of the computing system 10 may include one or more memories 14, one or more processor devices 16, and/or one or more data structures 18. It is to be understood that the computing system 10 in some examples may include constituent elements in addition to those illustrated in FIG. 1. It is further noted that while the central computing device 12 and the data structure 18 are shown as separate components, in other implementations, the central computing device 12 and the data structure 18 could be implemented in a single component or could be implemented in a greater number of components than two. In examples where the central computing device 12 comprises software instructions that program the processor device 16 to carry out functionality discussed herein, functionality implemented by the central computing device 12 may be attributed herein to the processor device 16.

In the example of FIG. 1, the central computing device 12 may receive traffic data 20 from a plurality of traffic signals 22-1-22-N (collectively, traffic signals 22). Prior to the central computing device 12 receiving the traffic data 20, the traffic signals 22 may obtain the traffic data 20 via computing devices 24 (e.g., computing device 24-1) that are communicatively coupled to the traffic signals 22. In some implementations, the computing devices 24 may be attached to the traffic signals 22 or proximate to the traffic signals 22 and able to communicate wirelessly with the traffic signals 22 via a network. The computing devices 24 each comprise a memory 26 and a processor device 28. The computing devices 24 can be communicatively coupled to a radar device 30 and a camera 32. In some implementations, the radar device 30 and the camera 32 may be attached to a traffic signal from among the traffic signals 22 or proximate to one or more traffic signals from among the traffic signals 22 and able to communicate over a network wirelessly with the computing devices 24 that are communicatively coupled to the traffic signals 22. Each of the computing devices 24 communicatively coupled to each traffic signal of the traffic signals 22 may communicate with a radar device and a camera associated with the computing device (e.g., the computing device 24-2 can be communicatively coupled to a radar and camera) or with a radar device and a camera that are associated with more than one of the computing devices 24 (e.g., the computing device 24-1 and the computing device 24-N can be communicatively coupled to the radar device 30 and the camera 32).

The traffic data 20 may be based on radar data 34, such as vehicle speeds, collected by the radar device 30 and camera data 36, such as images, collected by the camera 32. For instance, the traffic data 20 may be based on the radar data 34 collected by the radar device 30 and the camera data 36 collected by the camera 32, and the radar device 30 and the camera 32 may be associated with one or more traffic signals from among the traffic signals 22, such as when the radar device 30 and the camera 32 are communicatively coupled to the computing device that is communicatively coupled to the one or more traffic signals. The traffic data 20 may be sent by the computing devices 24 to the central computing device 12 over a network, such as a private LTE or 4G network as non-limiting examples. The traffic data 20 may include at least one of a traffic signal identifier or id number associated with a traffic signal from among the traffic signals 22, a current date and a current time, such as the date and time at which the traffic data 20 was collected or sent over the network, a traffic speed (e.g., the average speed of the vehicles driving on the road), a traffic image URL to a location where the traffic image is stored, and a traffic congestion level. The traffic data 20 may, in some examples, be in the form of a JSON (JavaScript Object Notation) that includes the traffic signal identifier, date, time, traffic speed, traffic image URL, and traffic congestion level associated with the traffic signals 22. The central computing device 12 may store the traffic data 20 in the data structure 18. The traffic data 20 stored in the data structure 18 may be encrypted and protected by access controls that permit authorized users to access the traffic data 20.

The central computing device 12 may receive a request 38 from a computing device 40 for information associated with the traffic data 20. The request 38 may be an Application Programming Interface (API) request from the computing device 40 for the information associated with the traffic data 20, such as information about locations with heavy traffic, routes, maps, and travel times based on the traffic in an area, as non-limiting examples. The computing device 40 may be a vehicle 42, such as an autonomous vehicle or an emergency service vehicle, or a user device 44 (e.g., a phone, tablet, wearable device, or laptop) associated with a user of a vehicle, as non-limiting examples. In some implementations, the request 38 may be an API request from the computing device 40 for the traffic data 20. The API request 38 may be sent from the computing device 40 from any location, such as a driver who wants to check traffic conditions on a route in real-time via the driver's computing device (e.g., the user device 44). In some implementations, the API request 38 may be based on a location 62 of the computing device 40. For instance, the API request 38 may include the location 62 of the computing device 40 and the central computing device 12 can use the location 62 to obtain, from the data structure 18, the traffic data 20 or the information associated with the traffic data 20 that is associated with the traffic signals 22 within a range of the location 62.

The central computing device 12 may generate a result 46 based on the traffic data 20 and the request 38 for information associated with the traffic data 20 in real-time. The result 46 may be at least one of an alert 48, a route 50, a traffic map 52, or a travel time 54, as non-limiting examples. For instance, the central computing device 12 may use machine learning to determine the amount of traffic congestion on the roads or at an intersection associated with the traffic signals 22 based on the traffic data 20, and use the amount of traffic congestion to generate the result 46. The central computing device 12 may send the result 46 to the computing device 40. The result 46 may also be stored in the data structure 18 and may be retrieved from the data structure 18, such as by querying the data structure 18, by the central computing device 12, the computing device 40, or another device of the computing system 10. In embodiments where the request 38 is an API request, the central computing device 12 may send an API response 56 to the computing device 40 and the API response 56 may include the result 46. After the sending the result 46 from the central computing device 12 to the computing device 40, the computing device 40 may perform an action 58 based on the result 46. For example, the traffic data 20 may indicate that there is heavy traffic at a traffic signal close by and the request 38 for information associated with the traffic data 20 may be a request for a route around the heavy traffic. The central computing device 12 can use the traffic data 20 and the request 38 for the route to generate the result 46 of a route around the heavy traffic, which can be sent by the central computing device 12 to the computing device 40. The computing device 40 can then perform the action 58 in real-time, such as re-routing to take the route 50 when the computing device 40 is a component of an autonomous vehicle (e.g., the vehicle 42) or displaying the route in a mapping application when the computing device 40 is a user computing device (e.g., the user device 44).

In embodiments where the request 38 is an API request from the computing device 40 for the traffic data 20, the central computing device 12 may retrieve the traffic data 20 from the data structure 18 and send an API response 56 that includes the traffic data 20 to the computing device 40. For instance, the central computing device 12 may retrieve the traffic data 20 from a database that stores the traffic data 20 for a traffic signal of the traffic signals 22 (e.g., the data structure 18) by querying the database with a traffic signal identifier, which may be identified in the request 38 or be based on a location, to retrieve a record of the traffic data 20 for the traffic signal with the traffic signal identifier from the query. The computing device 40 may then receive the API response 56 from the central computing device 12 and generate a route 60 based on the traffic data 20 in the API response 56. The traffic data 20 may be one or more JSONs and the JSONs can include identifiers for each traffic signal of the traffic signals 22, traffic images, and a traffic congestion level associated with the traffic signal. The API response 56 may include the traffic data 20 JSONs which the computing device 40 can parse for information to use when generating the route 50. For example, the traffic data 20 may identify intersections that are blocked and the computing device 40 may generate the route 50 to go around the blocked intersections based on the traffic data 20.

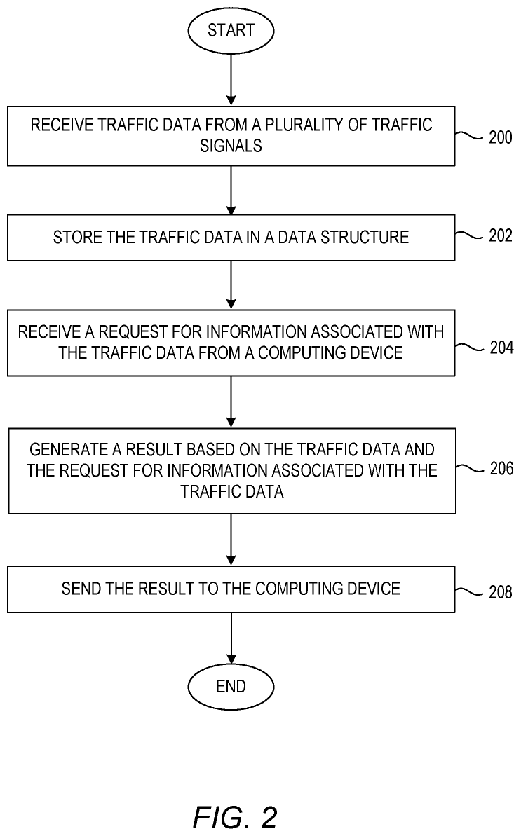

FIG. 2 is a flowchart illustrating operations performed by the computing system of FIG. 1 for real-time traffic information generation using smart traffic signals, according to one example. Elements of FIG. 1 are referenced in describing FIG. 2 for the sake of clarity. In FIG. 2, operations begin with a processor device of a computing device, such as the processor device 16 of the central computing device 12 of FIG. 1, the processor device 16 to receive the traffic data 20 from the plurality of traffic signals 22 (block 200). The processor device 16 is further to store the traffic data 20 in the data structure 18 (block 202). The processor device 16 is further to receive the request 38 for information associated with the traffic data 20 from the computing device 40 (block 204). The processor device 16 is further to generate the result 46 based on the traffic data 20 and the request 38 for information associated with the traffic data 20 (block 206). The processor device 16 is further to send the result 46 to the computing device 40 (block 208).

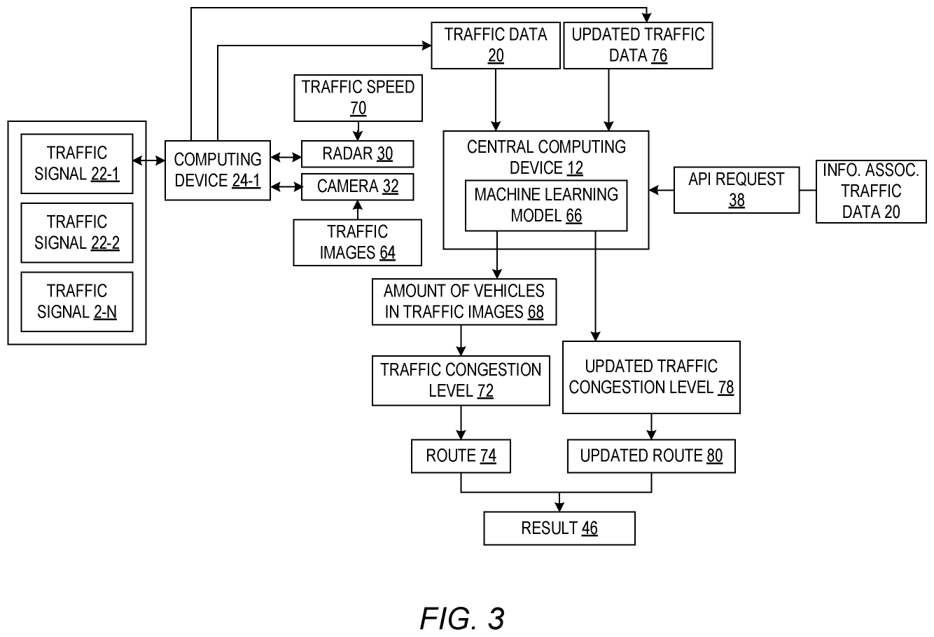

FIG. 3 is a block diagram of the computing system of FIG. 1 for real-time traffic information generation using smart traffic signals, according to one example. Elements of FIG. 1 are referenced in describing FIG. 3 for the sake of clarity. In the example of FIG. 3, the central computing device 12 may generate the result 46 by obtaining traffic images 64 from the traffic data 20. The traffic images 64 may correspond to a traffic signal of the traffic signals 22. For instance, the traffic data 20 may identify traffic signal 22-1 with a traffic signal identifier and include the traffic images 64 associated with the traffic signal 22-1, such as images taken by the camera 32, by providing a link to a location where the traffic images 64 are stored and can be retrieved by the central computing device 12. The central computing device 12 may include a machine-learning model 66 that has been trained on traffic images and prior traffic data from the traffic signals 22. The machine-learning model 66 can determine an amount of vehicles 68 in the traffic images 64, such as by counting the number of vehicles in the traffic images 64 or identifying outlines of vehicles and road lines, as non-limiting examples. The central computing device 12 may obtain a traffic speed 70 from the traffic data 20. The traffic speed 70 may correspond to a traffic signal of the traffic signals 22. For instance, the traffic data 20 may identify traffic signal 22-1 with a traffic signal identifier and include the traffic speed 70 associated with the traffic signal 22-1, such as speeds of vehicles taken by the radar device 30 associated with the traffic signal 22-1.

The machine-learning model 66 can determine a traffic congestion level 72 based on the amount of vehicles 68 in the traffic images 64 and the traffic speed 70. The traffic congestion level 72 may be a metric, such as a number or percentage that identifies an amount of traffic congestion on the roads, or a rating or grouping, such as “low,” “moderate,” or “high,” as non-limiting examples. The central computing device 12, such as by the machine-learning model 66, can generate the result 46 that is sent from the central computing device 12 to the computing device 40 based on the traffic congestion level 72. For example, the traffic congestion level 72 may be “high” at traffic signal 22-1 and the result 46 generated by the central computing device 12, such as by the machine-learning model 66, may be the route 50 or the traffic map 52 with detours around the traffic signal 22-1 or the travel time 54 may be increased based on the high traffic congestion at traffic signal 22-1.

In some embodiments, the central computing device 12 may generate the result 46 by obtaining the traffic images 64 from the traffic data 20, determining, by the machine-learning model 66, the amount of vehicles 68 in the traffic images 64, determining, by the machine-learning model 66, the traffic congestion level 72 based on the amount of vehicles 68 in the traffic images 64, and generating the result 46 that is sent from the central computing device 12 to the computing device 40 based on the traffic congestion level 72. In other embodiments, the central computing device 12 may generate the result 46 by obtaining the traffic speed 70 from the traffic data 20, determining, by the machine-learning model 66, the traffic congestion level 72 based on the traffic speed 70, and generating the result 46 that is sent from the central computing device 12 to the computing device 40 based on the traffic congestion level 72.

The central computing device 12, such as by the machine-learning model 66, can generate a route 74 based on the traffic data 20 and the traffic congestion level 72, and the result 46 sent from the central computing device 12 to the computing device 40 can include the route 74. The computing device 40 can use the route 74, such as displaying the route 74 in a mapping application of the user device 44 or in a display console of the vehicle 42, as non-limiting examples. For instance, the user device 44 may be a computing device of a first responder in an emergency vehicle that can display the route 74 to take to quickly get to the emergency vehicle's destination. For example, the traffic data 20 may identify intersections that are blocked, the traffic congestion level 72 may be “moderate,” and the central computing device 12 may generate the route 74 to go around the blocked intersections and the moderate traffic and send the route 74 to the computing device 40 to use.

The central computing device 12 may receive updated traffic data 76 from the traffic signals 22 (e.g., from the computing devices 24) and determine an updated traffic congestion level 78 based on the updated traffic data 76. For instance, the central computing device 12 can obtain new or updated traffic images and/or new or updated traffic speeds from the updated traffic data 76, the machine-learning model 66 can determine an amount of vehicles in the updated traffic images, and the machine-learning model 66 can determine the updated traffic congestion level 78 based on the amount of vehicles in the new or updated traffic images and/or the new or updated traffic speeds. The central computing device 12, such as by the machine-learning model 66, can generate an updated route 80 based on the updated traffic data 76 and the updated traffic congestion level 78, and the result 46 sent from the central computing device 12 to the computing device 40 can include the updated route 80. The computing device 40 can use the updated route 80, such as a mapping application of the user device 44 or the vehicle 42 that can re-route the driver and display the updated route 80, as non-limiting examples.

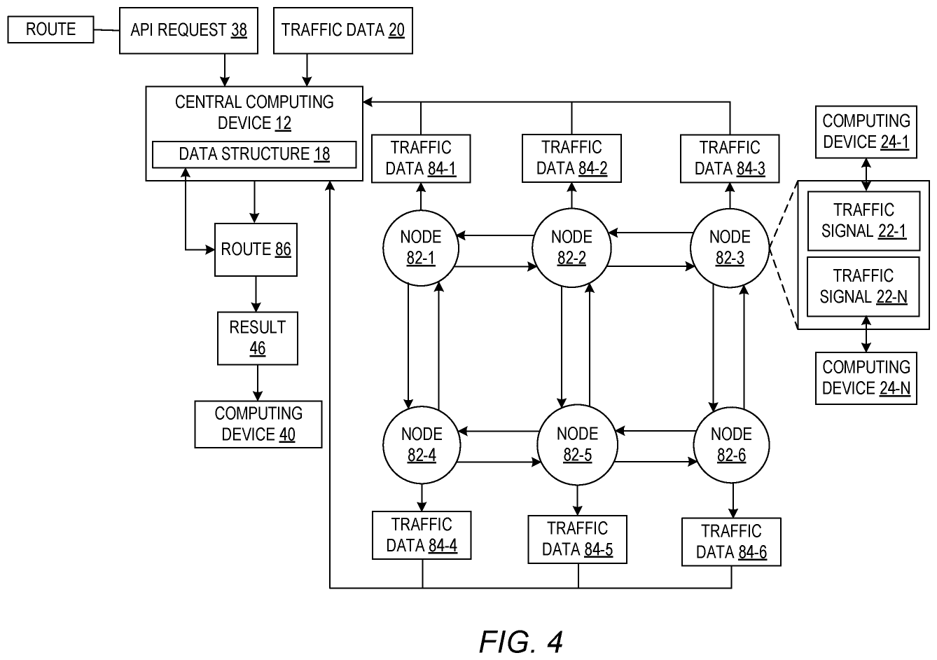

FIG. 4 is a block diagram of the computing system of FIG. 1 for real-time traffic information generation using smart traffic signals, according to one example. Elements of FIG. 1 are referenced in describing FIG. 4 for the sake of clarity. In the example of FIG. 4, the central computing device 12 may generate the result 46 by determining that an intersection is blocked based on the traffic data 20. The intersection may be an intersection from among a plurality of intersections 82-1-82-6 (collectively, intersections 82) and each intersection of the intersections 82 may include one or more of the traffic signals 22. For instance, intersection 82-1 may include traffic signal 22-1 and traffic signal 22-2. The central computing device 12 can determine that the intersection is blocked by obtaining the traffic images 64 and/or the traffic speed 70 that correspond to the traffic signals in the intersection from the traffic data 20 and determine, such as by the machine-learning model 66, that the traffic congestion level 72 is high based on the traffic images 64 and/or the traffic speed 70. The central computing device 12 may receive traffic data 84 (e.g., traffic data 84-1-84-6) for each traffic signal in the blocked intersection and for each traffic signal that is adjacent to the blocked intersection from the computing devices 24. The central computing device 12, such as by the machine-learning model 66, can generate a route 86 based on the traffic data 84 for each traffic signal in the blocked intersection and for each traffic signal that is adjacent to the blocked intersection in order to move traffic away from the blocked intersection. The result 46 sent from the central computing device 12 to the computing device 40 can include the route 86. The computing device 40 can use the route 86, such as a mapping application of the user device 44 or the vehicle 42 that can re-route the driver and display the route 86, as non-limiting examples. The route 86 may also be stored in the data structure 18. When the route 86 is stored in the data structure 18, the central computing device 12 may receive the API request 38 for the route 86 from the computing device 40 and retrieve the route 86 from the data structure 18, then send the route 86 to the computing device 40.

For example, the central computing device 12 may determine that intersection 82-3 with traffic signal 22-1, traffic signal 22-2, and traffic signal 22-3 is blocked based on the traffic data 20 that corresponds to the traffic signals in the intersection. The central computing device 12 can receive traffic data 84-3 from traffic signal 22-1, traffic signal 22-2, and traffic signal 22-3 in the blocked intersection, traffic data 84-2 from the traffic signals in intersection 82-2 which is adjacent to the blocked intersection 82-3, and traffic data 84-6 from the traffic signals in intersection 82-6 which is adjacent to the blocked intersection 82-3. The blocked intersection 82-3 can be separated from the unblocked intersections based on the traffic data 84, and the central computing device 12, such as by the machine-learning model 66, can create a path (e.g., the route 86) to divert traffic away from the blocked intersection 82-3 and send the path to the computing device 40 and/or store the path in the data structure 18.

In some implementations, the request 38 for information associated with the traffic data may be an API request for a route sent by the computing device 40 and the central computing device 12 may generate the result 46 of a route as requested in the API request. For example, a user may request a route due to traffic and use the user device 44 to send an API request for a new route. The central computing device 12 can obtain the traffic data 20, determine that an intersection is blocked, receive updated traffic data 84 from each traffic signal in the blocked intersection and adjacent to the blocked intersection, generate the route 86 based on the traffic data 84, and send the route 86 to the user device 44 that requested the route in real-time.

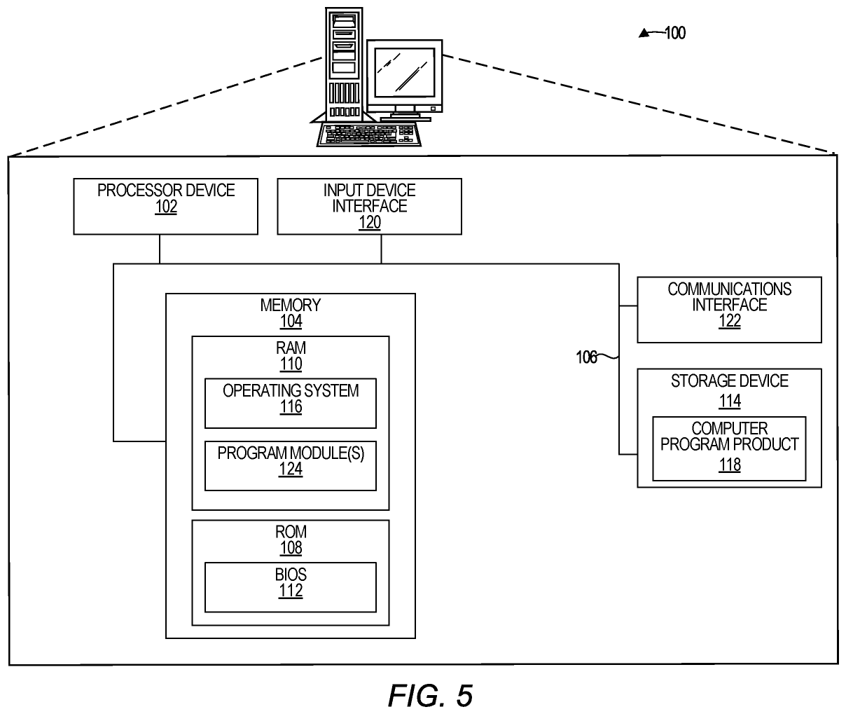

FIG. 5 is a block diagram of a computing device 100, such as the central computing device 12 of the computing system 10, suitable for implementing examples according to one example. The computing device 100 may comprise any computing or electronic device capable of including firmware, hardware, and/or executing software instructions to implement the functionality described herein. The computing device 100 includes a processor device 102, such as the processor device 16, a system memory 104, such as the memory 14, and a system bus 106. The system bus 106 provides an interface for system components including, but not limited to, the system memory 104 and the processor device 102. The processor device 102 can be any commercially available or proprietary processor.

The system bus 106 may be any of several types of bus structures that may further interconnect to a memory bus (with or without a memory controller), a peripheral bus, and/or a local bus using any of a variety of commercially available bus architectures. The system memory 104 may include non-volatile memory 108 (e.g., read-only memory (ROM), erasable programmable read-only memory (EPROM), electrically erasable programmable read-only memory (EEPROM), etc.), and volatile memory 110 (e.g., random-access memory (RAM)). A basic input/output system (BIOS) 112 may be stored in the non-volatile memory 108 and can include the basic routines that help to transfer information between elements within the computing device 100. The volatile memory 110 may also include a high-speed RAM, such as static RAM, for caching data.

The computing device 100 may further include or be coupled to a non-transitory computer-readable storage medium, such as a storage device 114, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 114 and other drives associated with computer-readable media and computer-usable media may provide non-volatile storage of data, data structures, computer-executable instructions, and the like.

A number of modules can be stored in the storage device 114 and in the volatile memory 110, including an operating system 116 and one or more program modules 124 (e.g., the data structure 18), which may implement the functionality described herein in whole or in part. All or a portion of the examples may be implemented as a computer program product 118 stored on a transitory or non-transitory computer-usable or computer-readable storage medium, such as the storage device 114, which includes complex programming instructions, such as complex computer-readable program code, to cause the processor device 102 to carry out the steps described herein. Thus, the computer-readable program code can comprise software instructions for implementing the functionality of the examples described herein when executed on the processor device 102. The processor device 102 may serve as a controller, or control system, for the computing device 100 that is to implement the functionality described herein.

An operator, such as a user, may also be able to enter one or more configuration commands through a keyboard (not illustrated), a pointing device such as a mouse (not illustrated), or a touch-sensitive surface such as a display device (not illustrated). Such input devices may be connected to the processor device 102 through an input device interface 120 that is coupled to the system bus 106 but can be connected by other interfaces such as a parallel port, an Institute of Electrical and Electronic Engineers (IEEE) 1394 serial port, a Universal Serial Bus (USB) port, an IR interface, and the like. The computing device 100 may also include a communications interface 122 suitable for communicating with the network as appropriate or desired. The computing device 100 may also include a video port (not illustrated) configured to interface with the display device (not illustrated), to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
receiving, by a central computing device comprising a data structure, traffic data from a plurality of traffic signals;
storing, by the central computing device, the traffic data in the data structure;
receiving, by the central computing device, a request for information associated with the traffic data from a computing device;
generating, by the central computing device, a result based on the traffic data and the request for information associated with the traffic data; and
sending, by the central computing device, the result to the computing device.

2. The method of claim 1, further comprising:
prior to receiving the traffic data, obtaining, by computing devices communicatively coupled to each traffic signal of the plurality of traffic signals, the traffic data based on radar data and camera data associated with the plurality of traffic signals.

3. The method of claim 1, wherein receiving the request for information associated with the traffic data from the computing device comprises receiving an API request for information associated with the traffic data from the computing device.

4. The method of claim 1, wherein receiving the request for information associated with the traffic data from the computing device comprises receiving an API request for the traffic data from the computing device.

5. The method of claim 4, further comprising:
retrieving, by the central computing device, the traffic data from the data structure; and
sending, by the central computing device, an API response to the computing device, wherein the API response includes the traffic data.

6. The method of claim 5, further comprising:
receiving, by the computing device, the API response from the central computing device; and
generating, by the computing device, a route based on the traffic data in the API response.

7. The method of claim 4, wherein the API request for the traffic data is based on a location of the computing device.

8. The method of claim 1, wherein sending the result to the computing device comprises sending an API response from the central computing device to the computing device, wherein the API response includes the result.

9. The method of claim 1, wherein generating the result based on the traffic data and the request for information associated with the traffic data comprises:
determining, based on the traffic data, that an intersection comprising one or more of the plurality of traffic signals is blocked;
receiving traffic data for each traffic signal in the intersection and traffic data for each traffic signal adjacent to the intersection; and
generating a route based on the traffic data for each traffic signal in the intersection and the traffic data for each traffic signal adjacent to the intersection;
wherein the result comprises the route.

10. The method of claim 9, wherein the request for information associated with the traffic data comprises an API request for a route from the computing device.

11. The method of claim 9, further comprising:
storing, by the central computing device, the route in the data structure;
receiving, by the central computing device, an API request for the route from the computing device;
retrieving, by the central computing device, the route from the data structure; and
sending, by the central computing device, the route to the computing device.

12. The method of claim 1, wherein generating the result based on the traffic data and the request for information associated with the traffic data comprises:
obtaining, from the traffic data, one or more traffic images corresponding to the plurality of traffic signals;
determining, by a machine-learning model, an amount of vehicles in the one or more traffic images;
obtaining, from the traffic data, a traffic speed corresponding to each traffic signal of the plurality of traffic signals;
determining, by the machine-learning model based on the amount of vehicles in the one or more traffic images and the traffic speed, a traffic congestion level; and
generating, by the machine-learning model, a route based on the traffic data and the traffic congestion level;
wherein the result comprises the route.

13. The method of claim 12, further comprising:
receiving updated traffic data from the plurality of traffic signals;
determining, based on the updated traffic data, an updated traffic congestion level; and
generating an updated route based on the updated traffic data and the updated traffic congestion level;
wherein the result comprises the updated route.

14. The method of claim 1, further comprising:
subsequent to sending the result to the computing device, performing, by the computing device, an action based on the result.

15. The method of claim 1, wherein the result comprises at least one of an alert, a route, a traffic map, or a travel time.

16. The method of claim 1, wherein the computing device comprises at least one of an autonomous vehicle, an emergency services vehicle, or a user device.

17. A computing system, comprising:
a central computing device comprising a data structure, a memory, and a processor device coupled to the memory, the processor device to:
receive traffic data from a plurality of traffic signals;
store the traffic data in the data structure;
receive a request for information associated with the traffic data from a computing device;
generate a result based on the traffic data and the request for information associated with the traffic data; and
send the result to the computing device.

18. The computing system of claim 17, further comprising:
computing devices communicatively coupled to each traffic signal of the plurality of traffic signals, the computing devices comprising a memory and a processor device coupled to the memory, the processor device to:
prior to receiving the traffic data, obtain the traffic data based on radar data and camera data corresponding to the plurality of traffic signals.

19. The computing system of claim 17, further comprising:
a machine-learning model trained on prior traffic data from the plurality of traffic signals, the machine-learning model to:
receive one or more traffic images corresponding to the plurality of traffic signals and a traffic speed corresponding to each traffic signal of the plurality of traffic signals, wherein the traffic data comprises the one or more traffic images and the traffic speed;
determine an amount of vehicles in the one or more traffic images;
determine, based on the amount of vehicles in the one or more traffic images and the traffic speed, a traffic congestion level; and
generate a route based on the traffic data and the traffic congestion level;
wherein the result comprises the route.

20. A non-transitory computer-readable storage medium that includes computer-executable instructions that, when executed, cause one or more processor devices to:
receive traffic data from a plurality of traffic signals;
store the traffic data in a data structure;
receive a request for information associated with the traffic data from a computing device;
generate a result based on the traffic data and the request for information associated with the traffic data; and
send the result to the computing device.
